(19) United States
(12) Patent Application Publication
(10) Pub. No.: US 2003/0226151 A1
(43) Pub. Date: Dec. 4, 2003

(54) Content reproduction controller, data management device, storage-type content distribution system, content distribution method, content distribution server,control data transmission server, and program product therefor

(75) Inventors: Seiji Hamada, Sagamihara-Shi (JP); Takashi Ogura, Hachiouji-Shi (JP); Akimitsu Shiseki, Miyamae-Ku (JP)

Correspondence Address: RICHARD M. GOLDMAN, 371 ELAN VILLAGE LANE, SUITE 208, CA, 95134, US

(73) Assignee: International Business Machines Corporation, Armonk, NY

(21) Appl. No.: 10/444,608

(22) Filed: May 23, 2003

(30) Foreign Application Priority Data
May 30, 2002 (JP) 2002-157837

(51) Int. Cl. H04N 7/173; H04N 7/16

(52) U.S. Cl. 725/132; 725/140; 725/152

(57) ABSTRACT

Method, system, and program product for providing a content distribution method that enables the capability of controlling a content reproduction. Specifically, by distributing active metadata for controlling content reproduction, a user receiver can reproduce the content with a plurality of contents combined using descriptors included in the active metadata, skip the content partially, or restrict viewing of the content. The active metadata is updatable and the updating of the active metadata can be individually generated for each user on the basis of user information retained in the service provider server, thereby providing a good command of controlling the content for each user.

### FIELD OF THE INVENTION

The present invention relates to a content distribution method, a content reproduction controller, and the like.

### BACKGROUND

Conventionally, movies, various programs, and other content are normally distributed on the air from a broadcast station and reproduced in real time at a receiver such as a television set. Therefore, if a user is going to see the content when he or she feels like it, the user has to record the content into a videocassette recorder or the like.

Recently, time shifting devices or appliances, for example, a device referred to as set-top box or the like having both functions of a receiver and a data storage device have become popular. In the form of broadcasting using this kind of device, the content distributed on the air from a broadcast station may be stored in a hard disk drive or other data storage devices, so that a user can call and reproduce data of content that he or she wants to see from the data storage device when he or she feels like it.

In the storage-type device as described above, however, a huge volume of content data is stored in the data storage device. Accordingly, for the main purpose of the user's search for target content, data referred to as metadata including various information related to the content such as a content title, actors, producers, and information on features of a scene, for example, for extracting a specific scene is appended to individual content data when distributed. The user searches a plurality of items of content stored in the data storage device for the target content, using information included in the metadata as a key, by which the user can find and reproduce the target content.

In the above technology using the metadata, however, the data is used only for so-called passive purposes such as a search key for the user to find out a target content. The metadata is not used for active purposes such as restricting viewing or listening to the content. Moreover, an individual user cannot be restricted from viewing or listening to specific content since the same content and metadata are transmitted to all of the users.

For restricting viewing or listening to a content, there is a technology of distributing encrypted data as content data and sending a decryption key for decrypting the content data only to normal users having paid the charge for the account in the music data distribution field and the like.

This type of decryption key, however, is available only for a control to determine whether the content can be reproduced, but not available for more complicated controls. For example, the decryption key is not available for a control of enabling only a part of the content to be reproduced for preview instead of all the content and there is a need to create a demo content separately.

Thus, a clear need exists to enable using the metadata for active purposes such as targeting or limiting viewing, listening, downloading, and reproducing content items.

### SUMMARY OF THE INVENTION

The present invention is directed to this technical problem. It is an object of the present invention to provide a content distribution method and the like having a better command of the content reproduction control.

For this object, in a storage-type content distribution system according to the present invention, a content transmission unit transmits content and a control data transmission unit transmits control data for controlling reproduction of the content. The content transmission unit and control data transmission unit can be either integrated with or separated from each other. The content transmitted by the content transmission unit is stored in the content storage unit. The control data transmitted by the control data transmission unit is stored in an updatable state into the control data storage unit. When updating control data is received in a state that the control data is stored in the control data storage unit, the reproduction control unit controls the reproduction of the content stored in the content storage unit on the basis of the updating control data.

In the above, initial data can be transmitted from the control data transmission unit with the transmission of the content in the content transmission unit.

Additionally, if the system further has a user information storage unit that stores user information related to a user who properly receives (purchases) the content reproduction, data generated based on the user information can also be transmitted as updating control data for updating initial data of the control data.

In this manner, by referencing the updatable control data when reproducing the content, reproduced information of the content can be altered according to a version of the control data. For example, with the initial data having information that disables viewing content, updating control data having information of enabling viewing the content can be issued to only users satisfying predetermined conditions. Furthermore, by altering the information of the updating control data, only a part or all of the content can be reproduced or other various reproduction forms can be implemented. In the conventional technology as described above, the decryption key is sent for the encrypted content only. Therefore, on this point, the technology differs from the present invention wherein initial data of the control data is transmitted together with the content.

A content reproduction controller according to the present invention, which is to receive content, receives the content, search data for use in searching for the content, and control data for controlling the content reproduction from outside in a data receiver unit and storing them into a data storage unit. Then, a content reproduction control unit controls the content reproduction based on the control data when the content to be reproduced is specified as a result of searching with the search data.

At this point, the content reproduction control unit controls the content reproduction based on the control data of the latest version stored in the data storage unit. Furthermore, the content reproduction control unit can control reproduction by reproducing a content with a combination of a plurality of contents stored in the data storage unit, determining whether the content can be reproduced, and reproducing only a partial content on the basis of the control data.

The data management device according to the present invention stores the control data generated based on the user information into the control data storage unit and determines reproduced positions of the content distributed from outside on the basis of the control data in the content reproduction control unit. This type of data management device is suitable for being incorporated into the content reproduction controller described above.

In the above, the control data can include information for use in specifying a start position and a stop position for reproducing the content in the content reproduction control unit.

A content distribution server according to the present invention distributes updatable control data for controlling reproduction of the content distributed by the content distribution unit together with the content using the control data distribution unit.

Furthermore, the control data transmission server according to the present invention generates user-specific control data for each content in a control data generation unit on the basis of user attribute information stored in an attribute information storage unit and transmits the generated control data in a control data transmitter unit.

In a content distribution method according to the present invention implemented by the content distribution server and the control data transmission server in collaboration, data updating the control data is generated on the basis of the user attribute information and transmitted to a user terminal upon receiving a request from the user terminal after transmission of the content and of the initial control data for controlling the content reproduction.

The generated and transmitted updating data can contain data for specifying a start position and a stop position for reproducing the content and data for reproducing the content with a second content inserted in the middle of a first content reproduced.

The present invention can also be understood as a program for causing a computer device to execute processing of storing a content distributed from outside, storing control data generated on the basis of user information, and controlling content reproduction on the basis of the stored control data.

As set forth hereinbelow, it is possible to control viewing of a content at will according to the present invention.

### THE FIGURES

Various embodiments and exemplifications of our invention are illustrated in the appended Figures.

FIG. 1 is a diagram showing a configuration of a content distribution system according the embodiment;

FIG. 2 is a diagram showing an example of passive metadata;

FIG. 3 is a diagram showing an example of active metadata;

FIG. 4 is a diagram showing a processing flow in reproducing a content;

FIG. 5 is a diagram showing an example of initial data of the active metadata;

FIG. 6 is a diagram showing an example of another initial data of the active metadata; and

FIG. 7 is a diagram showing an example of reproduction of a content with a control of the active metadata.

### DETAILED DESCRIPTION

The preferred embodiments of the present invention will now be described in detail hereinafter with reference to the accompanying drawings.

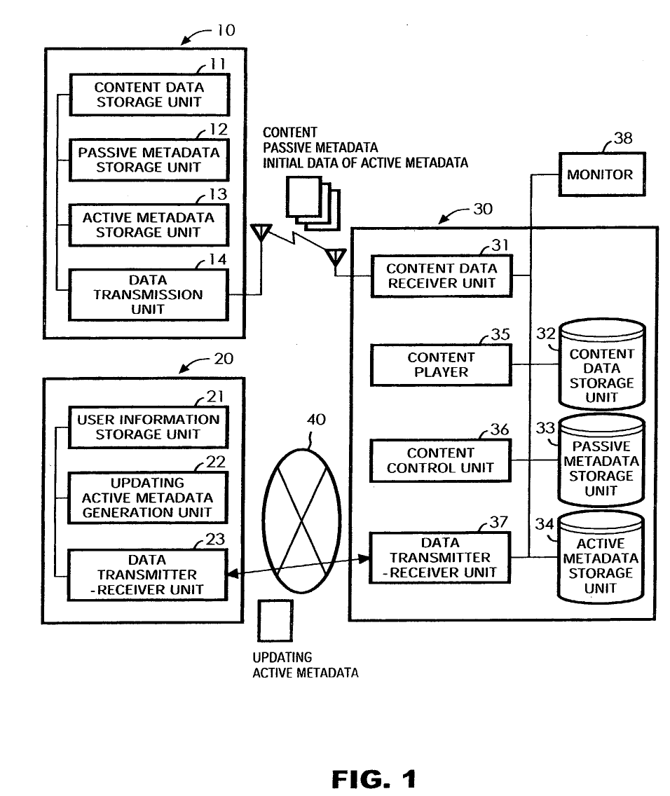

Referring to FIG. 1, there is shown a diagram illustrating the configuration of a content distribution unit in this embodiment.

As shown in FIG. 1, a content provider server (content distribution server) 10 transmits data (content items) of various contents. For example, the content provider server 10 transmits content data, passive metadata (search data), and initial data of active metadata (control data). A user receiver (content reproduction controller) 30 receives and stores the content data, the passive metadata, and the initial data of the active metadata.

A service provider server (control data transmission server) 20 transmits updating active metadata based on user attribute information via a network 40 to the user receiver 30, if necessary. The user receiver 30 receives and stores the updating active metadata from the service provider server 20.

Then, when reproducing the content on the basis of the content data, the receiver 30 references the initial data of the active metadata unless it has already received active metadata updating active metadata. The receiver 30 references the updating active metadata if it received the updating active metadata, so that the content reproduction is controlled based on the latest data.

The content provider server 10 comprises a content data storage unit 11 storing data of a plurality of previously produced contents, a passive metadata storage unit 12 storing passive metadata generated according to each content item (content item specific metadata) and including information mainly used for a search for a content, an active metadata storage unit 13 storing initial data of active metadata generated according to each content and controlling content reproduction, and a data transmitter unit (content transmission unit, control data transmission unit, content distribution unit, and control data distribution unit) 14 transmitting the content data stored in the content data storage unit 11, the passive metadata stored in the passive metadata storage unit 12, and the initial data of the active metadata stored in the active metadata storage unit 13.

The data transmitter unit 14 transmits the content and the passive metadata and the initial data of the active metadata corresponding to the content on the air on the basis of a predetermined time schedule. At this point, the data transmitter unit 14 does not transmit data according to individual users as the initial data of the active metadata, but transmits data common to all users such as, for example, data including information of a viewable part only for five minutes from the beginning of the content and a non-viewable remaining part.

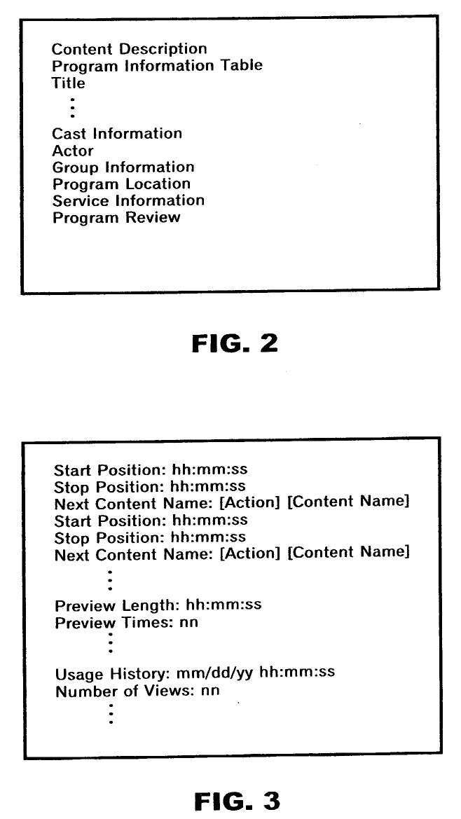

In FIG. 2, there is shown an example of passive metadata distributed together with the content data from the content provider server 10. As shown in this diagram, the passive metadata includes content-related information such as a content title, cast information, and actors. A user can search for a target content using the information as a key.

In FIG. 3, there is shown an example of active metadata. As shown in this diagram, active metadata includes descriptors such as “Start Position”, “Stop Position”, “Next Content Name”, “Preview Length”, “Preview Times”, “Usage History”, and “Number of Views”.

“Start Position” indicates a position where reproduction of the content data is started in terms of time, a time frame, or other information.

“Stop Position” indicates a position where reproduction of the content is halted or terminated.

“Next Content Name” indicates an action executed when one content under reproduction reached the position specified by “Stop Position” and a content name (or a content ID given to the content individually) to be an object of the action. Actions to be executed are:

“END” for terminating reproduction,

“CALL” for returning the control to the original content after reproducing another content,

“GOTO” for moving the control to another content,

“SELF” for reproducing its own content,

“RETURN” for returning the control to a called content, and

“WAIT” for halting reproduction.

“Preview Length” indicates a duration in which a user can preview, namely, view only a part of a content and “Preview Times” indicates the number of times a user can preview the content. “Usage History” indicates the last date and time when the content reproduced. “Number of Views” indicates the number of times the content was reproduced.

As shown in FIG. 1, the service provider server 20 comprises a user information storage unit (user information storage unit, attribute information storage unit) 21 storing attribute information of a previously registered user, an updating active metadata generation unit (control data generation unit) 22 generating updating active metadata on the basis of attribute information of individual users, and a data transmitter-receiver unit (control data transmission unit, control data transmitter unit) 23 transmitting generated updating active metadata to individual users via a network 40.

In the above, the attribute information of individual users stored in the user information storage unit includes whether the user paid the charge for the content account, an age or sex for identifying a user class, hobbies, and whether the user is registered on a specific membership organization.

The updating active metadata generation unit 22 can generate updating active metadata for users satisfying conditions based on an intention of a content creator, a content provider, or a content sponsor on the basis of the attribute information of individual users. The updating active metadata to be generated includes data permitting a user to view or listen to a full-length content or data permitting a user to view or listen to a content for free by inserting a specific advertisement (CM) in the middle of the content.

While the data transmitter-receiver unit 23 can transmit the updating active metadata to the receiver 30 upon receiving a request from the user receiver 30, the service provider server 20 can also transmit the updating active metadata to the receiver 30 at appropriate timing if a constant access to a network 40 is available in the receiver 30.

The user receiver 30 comprises a content data receiver unit (a data receiver unit) 31 receiving content data, passive metadata, and an initial data load of active metadata distributed from the content provider server 10 on the air, a content data storage unit (a data storage unit, content storage unit) 32 storing received content data, passive metadata, and active metadata, a passive metadata storage unit (a data storage unit) 33, an active metadata storage unit (a data storage unit, a control data storage unit, and control data storage unit) 34, a content player 35 reproducing and displaying a content on a monitor 38 on the basis of the content data stored in the content data storage unit 32, a content control unit (a content reproduction control unit, reproduction control unit) 36 controlling the content reproduction on the content player 35, and a data transmitter-receiver unit 37 receiving updating active metadata distributed from the service provider server 20.

If the data transmitter-receiver unit receives the updating active metadata, it is stored in the active metadata storage unit 34. At this time, the updating active metadata may be stored in the active metadata storage unit 34 instead of the initial data of the active metadata transmitted from the content provider server 10 after deleting the initial data. Otherwise, the updating active metadata may be stored with the initial data of the active metadata with the version information appended to the updating active metadata. Additionally the updating active metadata can be difference data relative to the initial data of the active metadata transmitted from the content provider server 10. After it is imported to the user receiver 30, the updating active metadata, which is the difference data, can be incorporated into the initial data of the active metadata, so that the data is stored in the active metadata storage unit 34.

The receiver 30 stores the content data, the passive metadata, and the active metadata corresponding to a plurality of contents sequentially distributed from the content provider server 10 into the content data storage unit 32, the passive metadata storage unit 33, and the active metadata storage unit 34.

In the above user receiver 30, the content control unit 36 references the passive metadata stored in the passive metadata storage unit 33 and the active metadata of the latest version stored in the active metadata storage unit 34 and controls reproduction of the content data stored in the content data storage unit 32 on the basis of the referenced data.

In the above, if the active metadata storage unit 34 stores only the initial data of the active metadata as active metadata corresponding to the reproduced content, the content control unit 36 references the initial data of the active metadata. If the active metadata storage unit 34 stores only the updating active metadata as active metadata corresponding to the reproduced content, the content control unit 36 references the updating active metadata. Furthermore, the active metadata storage unit 34 stores the initial data of the active metadata and the updating active metadata with version information as the active metadata corresponding to the reproduced content, the content control unit 36 references updating active metadata of the latest version.

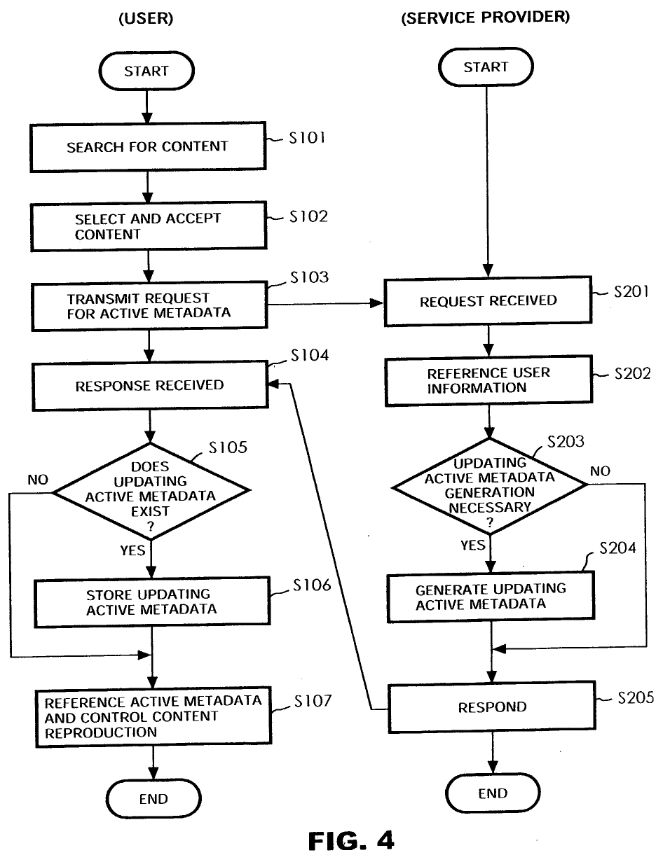

Referring to FIG. 4, there is shown a process flow executed by the user receiver 30 and the service provider server 20 when the receiver 30 reproduces a content.

When a user desires to reproduce the content, the user first searches a plurality of contents stored in the content data storage unit 32 for a target content using a controller for operating the receiver 30. For this operation, the user inputs a search condition such as a keyword or the like, by which the receiver 30 executes a search for information of the passive metadata stored in the passive metadata storage unit 33 (step S101) to list contents satisfying the search condition. In response to it the user selects a content to be reproduced out of the listed contents and the receiver accepts the content selection (step S 102).

Thereupon, in the receiver 30, the data transmitter-receiver unit 37 requests updating active metadata corresponding to the selected content from the service provider server 20 via the network 40. At this moment, the data transmitter-receiver unit 37 transmits information for identifying a user such as a user ID and information for identifying the selected content such as a content ID to the server 20, both being included in the request (step S103).

In the service provider server 20, the data transmitter-receiver unit 23 receives the request from the receiver 30 (step S201) and then the updating active metadata generation unit 22 references attribute information of a user identified by the user ID or the like included in the request (step S202). As set forth above, the user attribute information includes whether the user paid the charge for the content account, an age or sex for identifying a user class, hobbies, and whether the user is registered on a specific membership organization.

The updating active metadata generation unit 22 determines whether the updating active metadata need be generated on the basis of the referenced user attribute information (step S203). The determination is achieved by checking if the user satisfies the conditions for viewing or listening to the selected content on the basis of the reception conditions for viewing or listening to the content preset based on an intention of a content provider, a service provider, a content sponsor, or other content providing party.

If the user satisfies the conditions for viewing or listening to the content as a result of the determination, the updating active metadata generation unit 22 generates updating active metadata (step S204). Note that, however, it is also possible to call already-prepared one as the updating active metadata instead of generating it at this moment. Then, the data transmitter-receiver unit 23 transmits the generated updating active metadata via the network 40 to the user receiver 30 as a response to the request (step S205).

On the other hand, if the user does not satisfy the conditions for viewing or listening to the content and it is determined that the updating active metadata need not be generated in the step S203, the data transmitter-receiver unit 23 sends a response having a meaning of “no transmission of updating active metadata” in the step S205.

In the user receiver 30, the data transmitter-receiver unit 37 receives the response and checks if there is updating active metadata as a response; if so, the updating active metadata is stored in the active metadata storage unit 34 (steps S104 to S106).

Afterward, the content control unit 36 references active metadata, which is stored in the active metadata storage unit 34, corresponding to the selected content and it controls reproduction of the content (step S107).

The following describes how the content control unit 36 controls reproduction of the content by giving a concrete example of active metadata.

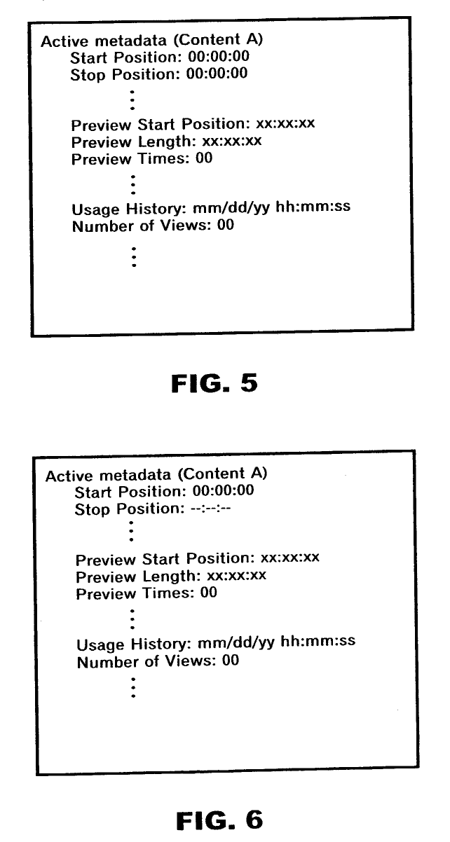

The active metadata in FIG. 5 is an example of initial data of the active metadata transmitted from the content provider server 10 or an example of the updating active metadata transmitted from the service provider server 20.

In FIG. 5, a descriptor “Stop Position: 00:00:00” in the active metadata unit that the content can be reproduced to the end. Therefore, the active metadata shows that a user can view or listen to a full-length content with “Start Position: 00:00:00”, in other words, from the beginning and with “Stop Position: 00:00:00”, in other words, to the end. This type of active metadata can be used as data added to a free content, for example.

If the active metadata storage unit 34 stores active metadata as shown in FIG. 5, the content control unit 36 references the active metadata and reproduces the full-length content stored in the content data storage unit 32 on the content player 35.

The active metadata in FIG. 6 is another example of the initial data of the active metadata transmitted from the content provider server 10 or an example of the updating active metadata transmitted from the service provider server 20.

In FIG. 6, a descriptor “Stop Position: --:--:--” indicated by (2) in the active metadata unit that the content cannot be reproduced.

If the active metadata storage unit 34 stores active metadata as shown in FIG. 6, the content control unit 36 references the active metadata and does not reproduce the content stored in the content data storage unit 32.

With this type of active metadata, viewing or listening to a content can be inhibited. Therefore, the active metadata can be used as initial data of active metadata for a pay content, for example. Furthermore, if the service provider server 20 transmits active metadata permitting content reproduction as shown in FIG. 5 as updating active metadata after the user paid the charge for the content, the user can reproduce the content.

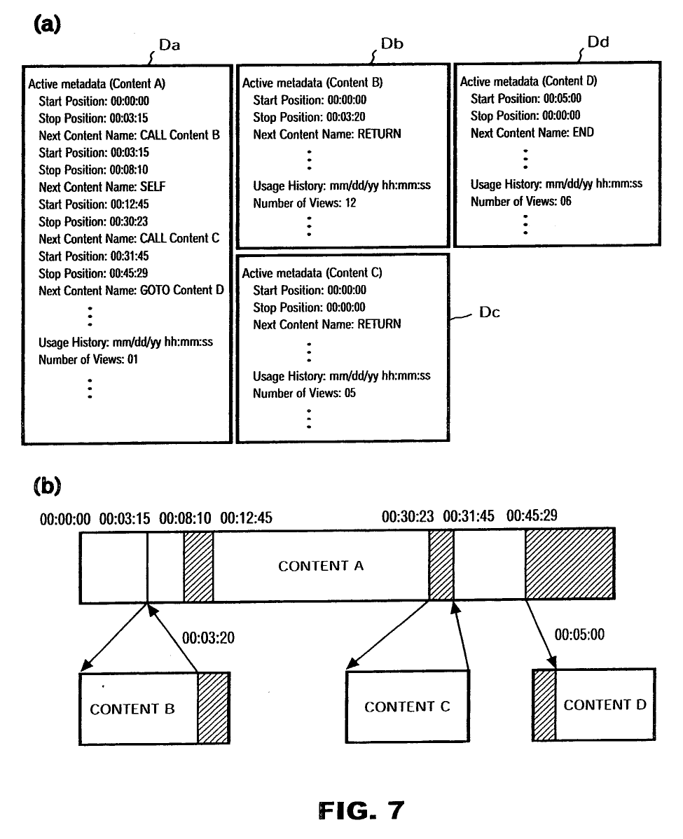

Active metadata Da, Db, Dc, and Dd in FIG. 7(a) correspond to a plurality of contents A, B, C, and D, respectively. The service provider server 20 transmits the active metadata Da, Db, Dc, and Dd as updating active metadata only to specific users (class) fulfilling the conditions that satisfy an intention of a sponsor. This may be on the basis of the information stored in the user information storage unit 21. Referring to FIG. 7(b), there is shown a diagram of a transition on a time chart of the plurality of contents A, B, C, and D reproduced based on the active metadata Da, Db, Dc, and Dd.

When the receiver 30 reproduces the content A based on a user request, the content control unit 36 first references the active metadata Da in FIG. 7(a) corresponding to the content A. Thereupon, the content control unit 36 reproduces the content A from position 00:00:00 to position 00:03:15 on the content player 35 on the basis of the descriptors “Start Position: 00:00:00” and “Stop Position: 00:03:15” of the active metadata Da.

Subsequently, the content control unit 36 calls the active metadata Db on the basis of the descriptor “Next Content Name: CALL content B”.

Then, the content control unit 36 references the active metadata Db this time. Thereupon, the content control unit 36 reproduces the content B from position 00:00:00 to position 00:03:20 on the content player 35 on the basis of the descriptors “Start Position: 00:00:00” and “Stop Position: 00:03:20” of the active metadata Db. Afterward, the content control unit 36 returns to the control of the original content A of the active metadata Da on the basis of the descriptor “Next Content Name: RETURN” of the active metadata Db.

With this, the content control unit 36 inserts the content B at a given position of the content A for reproduction.

The content control unit 36 references the active metadata Da and reproduces the content A from position 00:03:15 to position 00:08:10 on the content player 35 on the basis of descriptors “Start Position: 00:03:15” and “Stop Position: 00:08:10”. Afterward, the content control unit 36 continues the control of its own content A on the basis of descriptor “Next Content Name: SELF” of the active metadata Da. Subsequently, it reproduces the content A from position 00:12:45 to position 00:30:23 on the content player 35 on the basis of descriptors “Start Position: 00:12:45” and “Stop Position: 00:30:23”.

This skips the reproduction of the content A from the position 00:08:10 to the position 00:12:45. The descriptor “Next Content Name: SELF” enables the content A to be reproduced, or partially skipped. This enables a control to inhibit juveniles from viewing scenes of violence, for example.

The content control unit 36 calls the active metadata Dc on the basis of descriptor “Next Content Name: CALL Content C”.

The content control unit 36 references the called active metadata Dc. Thereupon, the content control unit 36 reproduces the full-length content C on the content player 35 on the basis of descriptors “Start Position: 00:00:00” and “Stop Position: 00:00:00” of the active metadata Dc. Afterward, the content control unit 36 returns to the control of the initial content A of the active metadata Da on the basis of a descriptor “Next Content Name: RETURN” of the active metadata Dc.

Herewith, the content control unit 36 reproduces the content with the content C inserted at a given position in the content A.

The content control unit 36 references the active metadata Da and reproduces the content A from position 00:31:45 to position 00:45:29 on the content player 35 on the basis of descriptors “Start Position: 00:31:45 ” and “Stop Position: 00:45:29”. Afterward, the content control unit 36 shifts to the control of the content D of the active metadata Dd on the basis of descriptor “Next Content Name: GOTO Content D” of the active metadata Da. Therefore, the content control unit 36 calls the active metadata Dd.

The content control unit 36 references the called active metadata Dd. Thereupon, the content control unit 36 reproduces the content D from position 00:05:00 to the end on the content player 35 on the basis of descriptors “Start Position: 00:05:00” and “Stop Position: 00:00:00” of the active metadata Dd. Afterward, the content control unit 36 terminates the control and the reproduction of the contents A, B, C, and D on the basis of a descriptor “Next Content Name: END” of the active metadata Dd.

In this manner, the content control unit 36 can reproduce the content with the first content A incorporating the contents B, C, and D as the second content. The contents B, C, and D can be an advertisement of goods or the like appealing to a specific user class. Therefore, the following control is possible: a sponsor inserts an advertisement of goods made of the contents B, C, and D into the content A for a specific user class such as, for example, women in their twenties, by which they can view the content A free.

Additionally the use of a descriptor “Next Content Name: SELF” enables a control of skipping a part of the content A.

Besides, the use of a descriptor “Number of View” enables restriction of viewing by the frequency of viewing the content.

In the above content distribution unit, active metadata corresponding to content data is distributed to users, by which descriptors included in the active metadata enable content reproduction with a combination of a plurality of contents, skipping a content partially, or restricting viewing of a content.

Furthermore, the active metadata includes the same initial data of the active metadata to be distributed to all users and to update active metadata generated according to a user, by which the system has an excellent command of content controls for each user.

Furthermore, in the service provider server 20, the user information storage unit 21 stores various attribute information of users and it can generate updating active metadata on the basis of the user attribute information. This enables the generation of updating active metadata according to user status or class, such as, for example, whether the user paid a charge for an account or advertising effectiveness, so that the content reproduction can be controlled. In this connection, upon receiving a request of content reproduction from a user, the system determines whether the user satisfies specific conditions and can transmit updating active metadata for permitting free viewing of a content only to a user satisfying the specific conditions. Users satisfying conditions based on an intention of a sponsor or the like are extracted from the user attribute information stored in the user information storage unit 21 and updating active metadata can be sent to the extracted users. With this, the content provider can make an active control of reproduction of a distributed content, by which good advertising effectiveness can be expected.

While the above embodiment shows the configuration in which the user receiver 30 seems to be separated from the monitor, they can be integrated with each other, in other words, they can have a form of a TV apparatus.

Furthermore, while the receiver 30 has a configuration for storing data of the content distributed from the content provider server 10 in the above embodiment, the present invention is not limited to this, but the same reproduction control as one in the above is achieved also for data of a content distributed via the network 40 in response to a user request and for content data stored in a storage medium such as a CD-ROM that a user has gotten and set to the receiver 30.

Still further, while there has been described a configuration in which the content provider server 10 is separated from the service provider server 20, they can be integrated with each other. If so, however, large-capacity and two-way network connection need be available for a communication with the user receiver 30.

The updating active metadata can be generated on any basis. It is not limited to a user class, but an appropriate and effective CM content can be inserted according to the timing or date for reproducing a content, for example.

Furthermore, although any description language can be used for the initial data of the active metadata or the updating active metadata, XML (extensible markup language) is preferable, for instance.

While the present invention has been described so as to have the active metadata storage unit 34 referenced in generating content data in the content control unit 36, the active metadata storage unit 34 can be a database device (data management device) like a relational database (RDB).

Naturally, a target content is not limited to one made of images and sounds like a movie, but can be only an image or sound, character information, map information or other additional information.

Additionally, the program executed in the content control unit 36 shown in the above embodiment can be stored in the following storage mediums. In other words, the above program executed by the computer device can be stored in a CD-ROM, a DVD, a memory, a hard disk or other storage mediums so that it is readable by the computer device.

Other than the above, modification within the spirit of the invention will be possible by sorting out components in the configuration in the above embodiment or by altering the configuration to another appropriately.

1. A content reproduction controller, comprising:
a data receiver unit for receiving content, search data for use in searching for the content, and control data for controlling reproduction of the content from outside;
a data storage unit for storing the content, the search data, the control data received by the data receiver unit; and
a content reproduction control unit for controlling reproduction of the content on the basis of the control data when the content is specified as a result of a search using the search data.

2. The controller according to claim 1, wherein the content reproduction control unit controls the content reproduction on the basis of the latest version of the control data stored in the data storage unit.

3. The controller according to claim 1, wherein the content reproduction control unit controls reproduction of the content stored in the data storage unit on the basis of the control data stored in the data storage unit.

4. The controller according to claim 1, wherein the content reproduction control unit controls reproduction of content stored in the data storage unit on the basis of the control data stored in the data storage unit.

5. The controller according to claim 1, wherein the content reproduction control unit reproduces only a part of the content stored in the data storage unit on the basis of the control data stored in the data storage unit.

6. A data management device, comprising:
a control data storage unit for storing control data generated on the basis of user information; and
a content reproduction control unit for determining a position where an externally distributed content is reproduced on the basis of the control data stored in the control data storage unit.

7. The device according to claim 6, wherein the control data storage unit stores the control data including information for specifying a start position and a stop position for reproducing the content in the content reproduction control unit.

8. A storage-type content distribution system, comprising:
a content transmission unit for transmitting content;
a control data transmission unit for transmitting control data for controlling reproduction of the content;
a content storage unit for receiving the content transmitted by the content transmission unit and storing the content;
a control data storage unit for receiving the control data transmitted by the control data transmission unit and storing the control data in an updatable state; and
a reproduction control unit for controlling reproduction of the content stored in the content storage unit on the basis of updating control data when the updating control data is received in a state that the control data storage unit stores the control data.

9. The system according to claim 8, wherein the control data transmission unit transmits initial data of the control data with the content transmission in the content transmission unit.

10. The system according to claim 9, further comprising the information storage unit storing user information on a user who reproduces content, wherein the control data transmission unit transmits data generated based on the user information stored in the user information storage unit as the updating control data for updating the initial data of the control data.

11. A method of distributing a content executed by a computer device, comprising the steps of:
transmitting initial data of control data for controlling the content and reproduction of the content;
generating updating data of the control data on the basis of attribute information indicating attributes of a user reproducing the content; and
transmitting the updating data to a user terminal.

12. The method according to claim 11, wherein the updating data generation is executed based on a request from the user terminal.

13. The method according to claim 11, wherein the updating data is generated including data for specifying a start position and a stop position for reproducing the content in the updating data generation step.

14. The method according to claim 11, wherein the updating data comprises data for reproducing content with second content inserted in the middle of first content reproduced in the updating data generation step.

15. A content distribution server, comprising:
a content distribution unit for distributing a content; and
a control data distribution unit for distributing updatable control data for controlling reproduction of the content distributed by the content distribution unit with the content.

16. A server for transmitting control data controlling content reproduction, comprising:
an attribute information storage unit storing attribute information indicating user attributes;
a control data generation unit for generating control data according to a user for each of the content on the basis of the attribute information stored in the attribute information storage unit; and
a control data transmission unit for transmitting the control data generated by the control data generation unit.

17. A program product causing a computer device to execute, comprising processes of:
storing a content distributed from outside;
storing control data generated based on user information; and
controlling reproduction of the content on the basis of the stored control data.
